(19) United States
(12) Patent Application Publication
(10) Pub. No.: US 2006/0084742 A1
(43) Pub. Date: Apr. 20, 2006

(54) Composite material and a method for producing the composite material by controlling distribution of a filler therein

(76) Inventors: Hatsuo Ishida, Shaker Heights, OH (US); Masuyuki Kawazoe, Sakaide (JP)

Correspondence Address: HUDAK, SHUNK & FARINE, CO., L.P.A., 2020 FRONT STREET, SUITE 307, CUYAHOGA FALLS, OH, 44221, US

(21) Appl. No.: 11/247,466

(22) Filed: Oct. 11, 2005

Related U.S. Application Data
(60) Provisional application No. 60/619,150, filed on Oct. 15, 2004.

(51) Int. Cl. C08K 3/26; C08K 3/04; C08K 3/34

(52) U.S. Cl. 524/425; 524/492; 524/495

(57) ABSTRACT

Composite materials having desirable properties due at least in part to controlled filler distribution within the composite and methods for preparing the composite materials are disclosed. In one embodiment, the composite material is derived from a blend of two or more substantially immiscible polymers, a solvent component, and at least one filler. The composite materials can be obtained in one embodiment by adding the polymers and filler to the solvent component, mixing the solutions for a period of time, and plating the solution to remove the solvent component and produce the composite material. The solvent component is chosen depending on the properties desired in the composite material and can have greater affinity for a first polymer or a second polymer, or substantially the same affinity for both polymers.

### FIELD OF THE INVENTION

The present invention relates to composite materials having desirable properties due at least in part to controlled filler distribution within the composite and methods for preparing the composite materials. It is believed that the polymer molecules are selectively confined into voids, particularly nano-scale voids of the aggregate structures of the filler during solution mixing. In one embodiment, the composite material comprises a blend of two or more substantially immiscible polymers, a solvent or mixture of solvents, and at least one filler. The composite materials can be obtained in one embodiment by adding the polymers and filler to the solvent, mixing the solution for a predetermined period of time, and drying the solution to remove the solvent and produce the composite material. The solvent is chosen based on the properties desired in the composite material and can have greater affinity for a first polymer or a second polymer, or substantially the same affinity for both polymers.

### BACKGROUND OF THE INVENTION

It is very difficult in an immiscible polymer blend to obtain highly controlled filler distribution. It is especially difficult to obtain uneven distribution of the filler to one of the polymers present or localization of the filler at the interface between the polymers utilizing a dry mixing method. The prior art composite materials are commonly prepared by dry blending or mixing polymers, fillers and other components with a mill, mixer, or kneader such as a Banbury or Hobart before further processing such as molding.

### SUMMARY OF THE INVENTION

Composite materials having tailored properties are disclosed. The composite materials comprise, at least one polymer and preferably two or more substantially immiscible polymers, a solvent or solvent mixture, and at least one filler component. The composite materials have a controlled filler distribution wherein the filler can be evenly distributed at the interface between polymeric materials or unevenly distributed around one of the polymers present, or a spectrum therebetween. It is believed that the polymer molecules are selectively confined into voids, particularly nano-scale voids of the aggregate structures of the filler during solution mixing.

The composite materials are produced in one embodiment by adding the substantially immiscible polymers and filler to a solvent thereby forming a solution. The solution is mixed for a predetermined period of time and subsequently dried to remove the solvent. The composite can be utilized directly or subjected to additional processing steps such as compression molding.

In a preferred embodiment the Hildebrand solubility parameters of the substantially immiscible polymers have a relatively small difference in order to obtain the benefits of improved properties in the composite materials. The difference in the solubility parameters of the immiscible polymers is generally between about 1.5 and about 3.5 MPa^{0.5}. Depending on the solvent utilized, it is possible to distribute the filler evenly between the polymers present, or arrange the filler around one of the polymers present.

Numerous different types of fillers can be utilized in the present invention including both conductive and non-conductive fillers. It is shown herein that nano-confinement of polymers within voids or other structure of the filler particle has been achieved with both conductive and non-conductive fillers. When an electrically conductive filler is dispersed in an insulating polymer system, a sudden jump in conductivity is observed when the concentration of the conductive filler exceeds a certain level which is called the percolation threshold concentration (“PTC”). Often, conductive carbon black is utilized as a filler for a conductive polymer composite because of its low price, good processability and corrosion-free surface. In one aspect of the present invention, solvents are utilized to modify the percolation threshold concentration of the conductive polymer composite, in particular the polymer system comprising styrene butadiene rubber, nitrile rubber, and carbon black. It is documented in the present invention that one sided polymer blends having weight ratios from about 90% to about 10% of a first polymer to a second polymer exhibit reduction in percolation threshold concentration utilizing a solution mixing method when compared to melt mixing methods predominately utilized in industry.

### BRIEF DESCRIPTION OF THE DRAWINGS

The invention will be better understood and other features and advantages will become apparent by reading the detailed description of the invention, taken together with the drawings, wherein:

FIGS. 1a and 1b illustrate a micrograph obtained utilizing an optical microscope observation of Example 1 and Comparative Example 1.

FIGS. 2a and 2b illustrate a micrograph obtained utilizing an optical microscope observation of Example 2 and Comparative Example 2.

FIGS. 3a and 3b illustrate a micrograph obtained utilizing an optical microscope observation of Example 3 and Comparative Example 3.

FIGS. 4a and 4b illustrate a micrograph obtained utilizing an optical microscope observation of Example 4 and Comparative Example 4.

FIG. 5 illustrates nitrile rubber and styrene-butadiene rubber mixture having silica distributed within the nitrile rubber solution phase.

### DETAILED DESCRIPTION OF THE INVENTION

The compositions of the present invention include composite materials comprising at least one polymer and preferably two or more substantially immiscible polymers each having a Hildebrand solubility parameter, hereinafter referred to as solubility parameter, which have similar values. The composite materials are prepared with a suitable solvent or a mixture of solvents that are utilized to modify the distribution state of a filler in the composite.

Hildebrand solubility parameter refers to a solubility parameter defined by the square root of the cohesive energy density of a material, having units of pressure (MPa^{0.5}), and being equal to (ΔH−RT)^{0.5}/V^{0.5}, where ΔH is the molar heat of vaporization of the material, R is the universal gas constant, T is the absolute temperature, and V is the molar volume of the solvent. Hildebrand solubility parameter values are, for example, tabulated in: Barton, A. F. M., Handbook of Solubility and Other Cohesion Parameters, 2nd Ed. CRC Press, Boca Raton, Fla., (1991), The Polymer Handbook, 3rd Ed., J. Brandrup & E. H. Immergut, Eds. John Wiley, NY, pp 519-557 (1989), and Barton, A. F. M., Handbook of Polymer-Liquid Interaction Parameters and Solubility Parameters, CRC Press, Boca Raton, Fla., (1990).

The solubility of a material in a given solvent may be predicted from the absolute difference in Hildebrand solubility parameter of the solute relative to the solvent. The solutes will exist as true solutions or in a highly solvated state when the absolute difference in Hildebrand solubility parameter is less than approximately 1.5 MPa^{0.5}. When the absolute difference in Hildebrand solubility parameter exceeds approximately 3.5 MPa^{0.5}, the solute is generally phase separated from the solute, forming a solid, substantially insoluble mass. Those solutes having an absolute difference in Hildebrand solubility parameters between about 1.5 MPa^{0.5} and about 3.5 MPa^{0.5} are considered to be weakly solvated or marginally insoluble.

Many different types of polymers are useful in the present invention. Preferred polymers are rubbers, thermoplastic elastomers, thermoplastics and uncrosslinked oligomers as a precursor to a crosslinked polymer. The term “polymer” when utilized herein refers to such oligomers, polymers and copolymers, unless specifically stated. The term “copolymer” is a polymer having two or more different monomers. Examples of suitable polymers include, but are not limited to, the following. Polymers derived from one or more olefin monomers having from 2 to about 10 carbon atoms such as polyethylene, polypropylene, polybutene, polypentene, and polyisobutylene can be utilized for this invention. The polymers from monoolefins can include repeat units from non-olefin monomers such as conjugated dienes or (meth)acrylic acid and include copolymers such as EP rubber, EPDM rubber, butyl rubber, poly(ethylene-co-acrylic acid) and poly(ethylene-co-methacrylic acid). Polymers also include those derived from conjugated dienes such as dienes having from 4 to about 8 carbon atoms and optionally halogenated monomers which form polymers such as polybutadiene, polyisoprene (natural or synthetic), polypentadiene, polyhexadiene, polyoctadiene, polychloroprene (neoprene), as well as copolymers, terpolymers, etc. which have at least 20, 30, or 50 weight percent repeating units from conjugated dienes such as styrene butadiene copolymers and nitrile rubber. Additional polymers include those derived from vinyl aromatic monomers such as styrene or various alkylated styrenes having from 8 to about 12 carbon atoms such as styrene, alpha-methyl styrene, t-butyl styrene, or any copolymers, terpolymers, etc. having at least 20, 30, or 50 weight percent repeating units from the vinyl aromatic monomers with styrene acrylonitrile copolymer being an example. Still other polymers include polyesters generally derived from diacids having from 3 to 20 carbon atoms and diols having from 1 to 20 carbon atoms such as poly(ethylene-terephthalate); polyesters prepared from the ring opening polymerization of cyclic esters having from 2 to 5 or 6 carbon atoms; poly(vinyl alcohol); polyacetal; poly(vinyl acetate); poly(alkyl) (alkyl)acrylates from (alkyl) acrylates having from 3 to about 30 carbon atoms such as poly(methyl methacrylate); halogenated polymers such as chlorinated polymers such as poly(vinyl chloride) and poly(vinylidene chloride) or fluoropolymers such as polytetrafluoroethylenes and poly(vinylidene fluoride); polycarbonates; polyamides from diacids having from 3 to 20 carbon atoms and diamines having from 1 to about 20 carbon atoms or from ring opening of caprolactams; polyethers having from 1 to about 6 carbon atoms per repeating unit; polysiloxanes; poly(acrylonitrile); poly(celluloses); polyurethanes; polyimides; polyacrylic acid; polyglycine; polynucleotides; poly(amic acid); polyoxymethylene; polypeptides; poly(alkylene oxides) such as poly(propylene oxide); and incompletely cured and soluble epoxies, urethanes, phenolics, unsaturated polyesters, urea formaldehydes, vinyl esters, cyanate esters, bismaleimides, crosslinkable polyimides, polybenzoxazines and the like; or combinations thereof.

While in some embodiments only a single polymer is utilized, preferably two or more substantially immiscible polymers are utilized to form the composite material. When two polymers are utilized, the first polymer is present in an amount generally from about 0.1 to about 50 parts, desirably from about 1 to about 30 parts, and preferably from about 5 to about 15 parts based on 100 parts by weight of the first polymer and second polymer.

The polymers utilized in the composite material are chosen so that the same have similar solubility parameters in order to achieve beneficial properties in the composite material. That said, the difference in solubility parameters between at least two polymers utilized in the composite material ranges generally from about 1.5 to about 3.5 MPa^{0.5}, desirably from about 1.8 to about 3.25 MPa^{0.5}, and preferably from about 2.0 to about 3.0 MPa^{0.5}. It is most preferred that all polymers utilized in the composite material are within the stated ranges. If the solubility parameter value difference is lower than about 1.5 MPa^{0.5}, the desired effect may be reduced in the composite material. Additionally, if the solubility parameters between two polymers is greater than about 3.5 MPa^{0.5}, it is difficult to find a common solvent in both of the polymers.

Many different types of fillers can be utilized to prepare the composite materials of the present invention. Suitable fillers for the present invention include both electrically conductive and non-conductive fillers. Preferred fillers comprise nanosize particles. Suitable fillers include, but are not limited to, carbon black, carbon black/silica dual phase materials, graphite, fullerene, carbon nanotube, silica, mica, talc, clay, kaolin, wollastonite, calcium carbonate, calcium hydroxide, calcium metasilicate, zinc oxide, zirconium oxide, titanium oxide, tin oxide, tungsten oxide, lead oxide, nickel oxide, magnesium oxide, copper oxide, barium hydroxide, alumina, aluminum hydroxide, aluminum silicate, ferrite, molybdenum disulfide, feldspar powder, wood powder, metal powder, carbon fiber, aramid fiber, alumina fiber, potassium titanate whisker, glass fiber, glass sphere, synthetic fiber, ceramic spheres or particles, various pigments, etc. The filler materials can be utilized individually or in combinations thereof. The filler is present in an amount generally from 0.1 to about 1000 parts, desirably from about 1 to about 50 or about 100 parts, and preferably from about 3 to about 15 parts based on 100 parts by weight of the polymer component.

The fillers utilized in the present invention have aggregate structures composed of primary particles. The aggregate structure is so strong that it cannot be destroyed while mixing. The aggregate structures of the filler contain numerous voids, particularly numerous nano-scale voids. Utilizing the solution mixing method of the present invention, the polymers are solvated to a degree such that portions thereof are small enough to be confined into the voids of the filler aggregate structure. In particular, the radius of gyration of one polymer is similar to the void size of the filler aggregate structure in order to achieve beneficial properties in a composite material. That said, when a particular solvent chosen has an affinity which is greater for a first polymer than a second polymer, the first polymer is dissolved to a greater extent, the molecular chains thereof have a relatively large spread and the radius of gyration is typically larger than can be confined in the voids of the filler. The second polymer, which is less solvated in the solvent and thus contains tighter molecular chains, can be confined in the voids of the filler selectively. Accordingly, nano-confinement of the polymer molecules into the voids of the filler aggregate can be utilized to modify properties of the final composite material, such as the PTC. Effect of nano-confinement is most prominently realized for nanosize particles, but also to micrometer sizes particles to a lesser extent.

The process for preparing the composite materials of the present invention utilizes one or more solvents in order to achieve desirable properties in the final product. Generally any solvent or solvent mixture can be utilized. Preferably the solvent utilized has a solubility parameter similar to the polymers utilized in the present invention. Preferably the solvent is able to dissolve or partially dissolve each polymer present in a chosen composition.

When the affinity between a solvent and a first polymer is greater than between the solvent and a second polymer, it is possible to make the filler unevenly distribute to the second polymer. Alternatively, when the affinity between the solvent and the second polymer is greater than that between the solvent and the first polymer, it is possible to make the filler unevenly distribute to the first polymer. Furthermore, when the affinities between the solvent and the first and second polymers are substantially equal, the filler is arranged at the interface between the first polymer and second polymer in the composite material. Hence, the choice of solvent is utilized to control the distribution state of a filler and thus the final structure of the composite material.

In a preferred embodiment, the solvent has a solubility parameter which is within generally about 1.5 MPa^{0.5} to about 3.5 MPa^{0.5}, desirably from about 1.8 to about 3.25 MPa^{0.5}, and preferably from about 2.0 to about 3.0 MPa^{0.5} of each polymer utilized in the composite material composition in order to achieve a desired effect on the properties of the composite material.

Examples of solvents suitable for use in the present invention followed by their solubility parameter (where known) include, but are not limited to, n-pentane (14.3), n-hexane (14.9), n-heptane (15.1), diethyl ether (15.4), 1,1,1-tributylamine (15.8), n-dodecane (16.2), turpentine (16.6), cyclohexane (16.8), amyl acetate (17.1), carbon tetrachloride (17.6), xylene (18.2), ethyl acetate (18.6), toluene (18.2), tetrahydrofuran (18.6), benzene (18.7), chloroform (19.0), trichloroethylene (18.8), Cellosolve® acetate (19.1), methyl ethyl ketone (19.0), acetone (20.3), diacetone alcohol (18.8), ethylene dichloride (20.1), methylene chloride (19.8), butyl Cellosolve® (20.2), pyridine (21.9), Cellosolve® (21.9), morpholine (22.1), dimethylformamide (24.8), n-propyl alcohol (24.3), ethyl alcohol (26.0), dimethyl sulfoxide (29.7), n-butyl alcohol (23.3), methyl alcohol (29.7), propylene glycol (25.8), ethylene glycol (29.9), glycerol (33.8), supercritical carbon dioxide, and water (47.9). The values are listed from Polymer Handbook, 4th Ed., J. Brandrup & E. H. Immergut, Eds. John Wiley, NY, pp 688-694, (1999).

The composite materials of the present invention can be prepared utilizing the following methods. In one embodiment, a predetermined amount of solvent is added to a tank or vessel. Subsequently predetermined amounts of polymer and filler are added thereto preferably with mixing. Any optional components can also be added to the solvent if desired in the composite material. The mixing process can be performed with generally any mixer such as a low speed or high speed mixer, or a sonification mixer for a predetermined length of time such that the desired degree of dispersion is achieved. Sonic and/or ultrasonic mixers are commercially available from Branson Ultrasonic Corporation of Danbury, Conn. The composite material solution is mixed for a period of time until the polymer(s) is substantially dissolved.

The solvent is removed from the composite material after the mixing process. The solvent can be removed via drying, evaporation, heating, or solvent stripping. In one embodiment, the composite material solution is placed on a relatively flat surface and the solvent evaporated therefrom to produce a sheet of material. In a further embodiment, the dried composite material is compression molded to any desired thickness.

In an alternative embodiment, the polymers and fillers are separately dispersed into the chosen solvent before being combined and remixed. Afterwards, the solvent is removed to produce the composite material.

One application for the disclosure of the present invention is as follows. First, two immiscible polymers are dissolved in a solvent. Styrene butadiene rubber (SBR) is used as polymer A while nitrile rubber (NBR) is utilized as polymer B. A suitable solvent which can substantially dissolve both polymers is chosen. If toluene is chosen for the solvent, the solubility parameters for the polymers and solvent are: SBR (about 17.5 MPa^{0.5}), NBR (about 20.0 MPa^{0.5}), and toluene (18.2 MPa^{0.5}). Accordingly, the solvent has high affinity for polymer A. On the other hand, if chloroform (19.0 MPa^{0.5}) is chosen for the solvent, chloroform has high affinity for solvent B. If THF (18.6 MPa^{0.5}) is utilized as a solvent, the affinity of the solvent for both polymers is similar. In addition to utilizing the solubility parameter to determine the affinity between the polymers and solvent, it is otherwise possible to judge the affinity by dissolving an equal amount of polymer into a solvent and measuring the imbalance of occupied volume of the polymers. It is still also possible to measure the hydrodynamic radius (Rh) of the polymer molecules in a solvent by dynamic light scattering (DLS) in order to measure affinity. In the measurement, the larger the molecular size, the higher affinity for the solvent.

In a preferred embodiment the concentration of the polymers is generally maintained below about 10 volume percent, desirably less than about 5 volume percent, and preferably less than about 2.5 volume percent in order to maintain a low viscosity for easier mixing. A filler dispersion can be prepared utilizing the same solvent as the polymer solution and subsequently add to the polymer solution wherein further mixing is performed. The filler is preferably utilized in concentration ranges similar to the polymers with respect to the amount of solvent.

The following examples serve to illustrate, but not to limit, the present invention.

### EXAMPLES

### Example 1

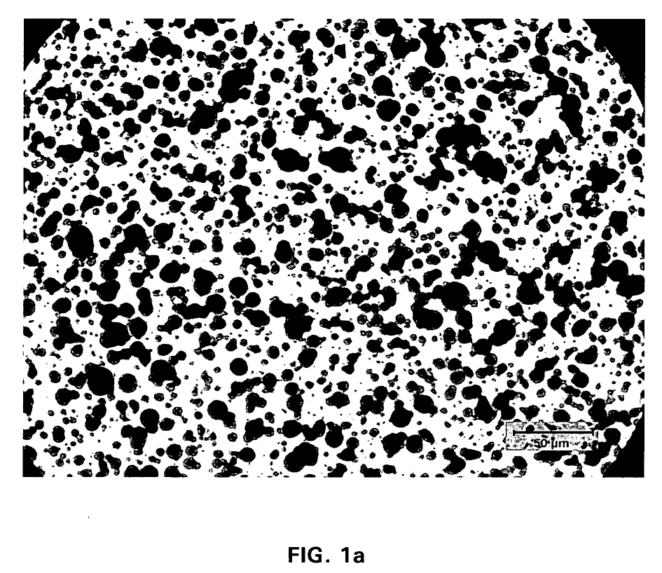

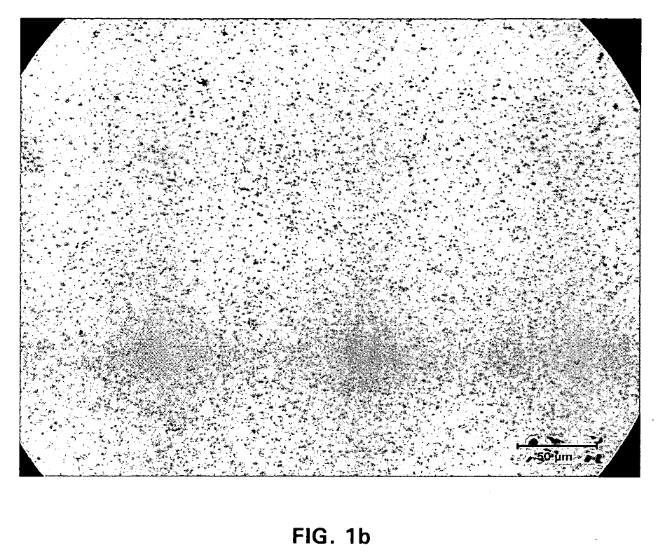

(A) 1.8 g of SBR (Zeon Corporation, Nipol 1502) and 0.2 g of NBR (Zeon Corporation, Nipol 1042) were dissolved into 20 ml of toluene. (B) 0.1 g of carbon black (Cabot Corporation, Monarch 880) was dispersed into 20 ml of toluene. Next, the polymer solution (A) was mixed with the carbon black dispersion (B), using a sonification machine for about 24 hours. To remove the solvent, the mixture was spread out on a tray and the material was dried for 24 hours in ambient temperature. The dried composite material was applied to compression mold to make 0.5 mm thick film, then, cut as a 6 mm diameter disk. The obtained disk's electrical resistance was converted to the electrical conductivity and the value was 1.0×10⁻⁶ S/cm. To check the distribution state of carbon black particles in the polymer blend, the solution mixture before the drying process was spin-cast on a piece of cover glass, and the obtained thin film's morphology was observed by an optical microscope, as shown in FIG. 1a.

### Comparative Example 1

45 g of SBR (Zeon Corporation, Nipol 1502) and 5 g of NBR (Zeon Corporation, Nipol 1042) were mixed by a Banbury mixer for 3 minutes. 2.5 g of carbon black (Cabot Corporation, Monarch 880) was added to the polymers and mixed for 10 minutes. The obtained composite material was applied to compression mold to make 0.5 mm thick film, then, cut as a 6 mm diameter disk. The obtained disk's electrical resistance was converted to the electric conductivity and the value was 0.8×10⁻¹⁰ S/cm.

According to this example, the electrical conductivity of the composite material obtained by the method of Example 1 is about 1,000 times higher than that of the composite material obtained by the conventional dry mixing method of comparative Example 1. This is because the carbon black was unevenly distributed and concentrated to the NBR phase and the phase formed very effective network to increase the electrical conductivity. This interpretation is clearly supported by the micrograph shown in FIG. 1a. On the other hand, in the case of conventional dry mixing method described in the comparative Example 1, the carbon black was diluted by the whole polymers, then, electric conductive phase was not formed (FIG. 1b). Therefore, it was revealed that electrically high conductive composite material was successfully fabricated only a small amount of carbon black addition when the solution mixing process which caused uneven distribution of the carbon black to the NBR phase was applied in this invention.

### Example 2

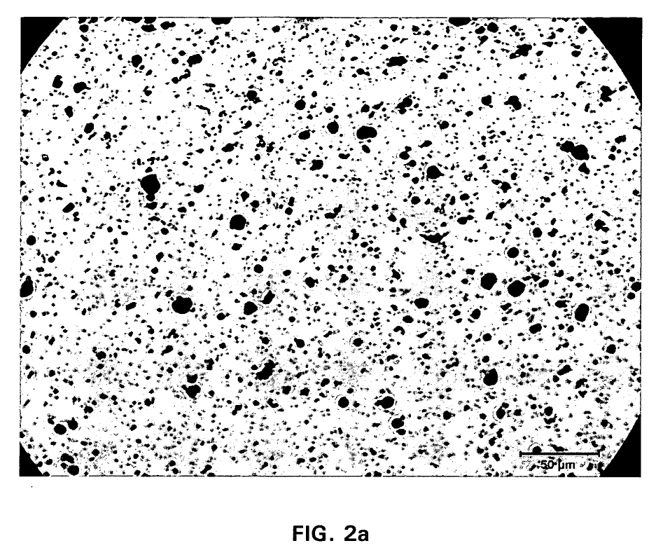

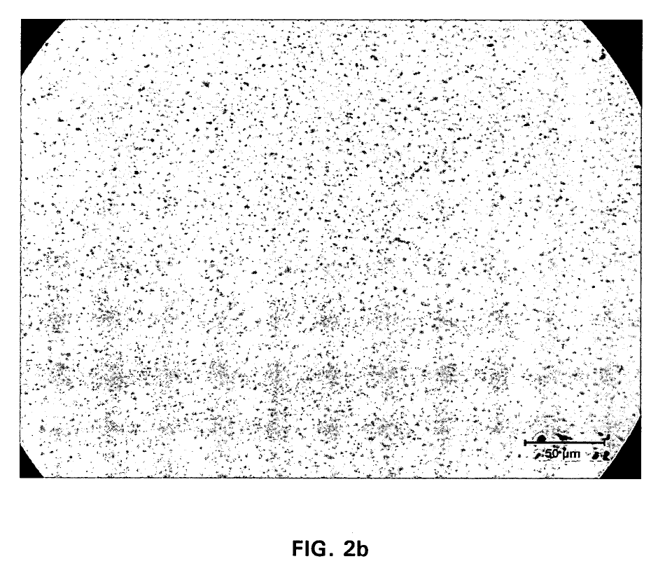

(A) 1.8 g of NBR (Zeon Corporation, Nipol 1042) and 0.2 g of SBR (Zeon Corporation, Nipol 1502) were completely dissolved into 20 ml of chloroform. (B) 0.1 g of carbon black (Cabot Corporation, Monarch 880) was dispersed into 20 ml of chloroform. Next, the polymer solution (A) was mixed with the carbon black dispersion (B) using a sonification machine for about 24 hours. The mixture was spread out on a tray and the material was dried for 24 hours in ambient temperature to remove the solvent. The dried composite material was applied to compression mold to make 0.5 mm thick film, then, cut as a 6 mm diameter disk. The obtained disk's electrical resistance was converted to the electrical conductivity and the value was 1.2×10⁻⁷ S/cm. Meanwhile to check the distribution state of carbon black particle in the polymer blend, the solution mixture before the drying process was spin-cast on a piece of cover glass, then, the obtained thin film's morphology was observed by an optical microscope, as shown in FIG. 2a.

### Comparative Example 2

45 g of NBR (Zeon Corporation, Nipol 1042) and 5 g of SBR (Zeon Corporation, Nipol 1502) were mixed by a Banbury mixer for 3 minutes, then, 2.5 g of carbon black (Cabot Corporation, Monarch 880) was added to the polymers and mixed for 10 minutes. The obtained composition material was applied to compression mold to make 0.5 mm thick film then, cut as a 6 mm diameter disk. The obtained disk's electrical resistance was converted to the electrical conductivity and the value was 0.3×10⁻⁹ S/cm.

According to this example, the electrical conductivity of the composite material obtained by the method of Example 2 is about 100 times higher than that of the composite material obtained by the conventional dry mixing method of comparative Example 2. This is because the carbon black was unevenly distributed and concentrated to the SBR phase and the phase formed very effective network to increase the electrical conductivity. This interpretation is clearly supported by the micrograph shown in FIG. 2a. On the other hand, in the case of conventional dry mixing method described in the comparative Example 2, the carbon black was diluted by the whole polymers, then, electric conductive phase was not formed (FIG. 2b). Therefore, it was revealed that electrically high conductive composite material was successfully fabricated only a small amount of carbon black addition when the solution mixing process which caused uneven distribution of the carbon black to the SBR phase was applied in this invention.

### Example 3

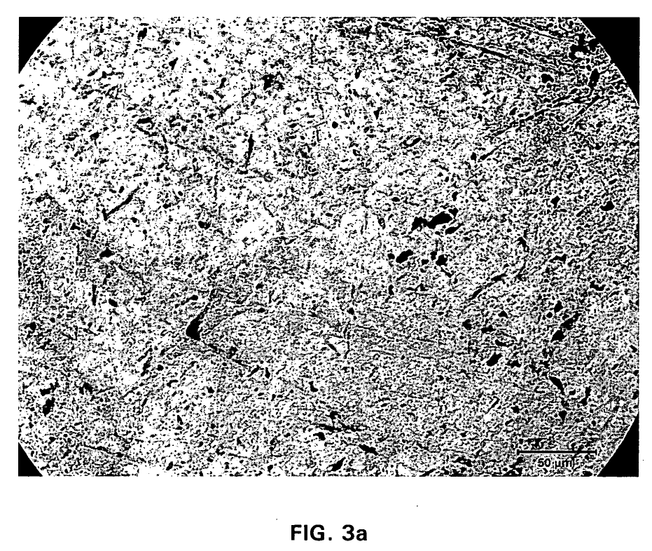

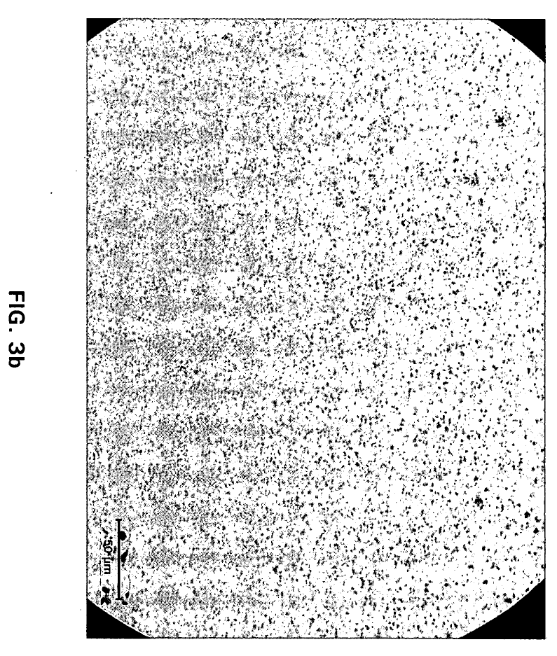

(A) 1.0 g of SBR (Zeon Corporation, Nipol 1502) and 1.0 g of NBR (Zeon Corporation, Nipol 1042) were completely dissolved into 20 ml of THF. (B) 0.1 g of carbon black (Cabot Corporation, Monarch 880) was dispersed into 20 ml of THF. Next, the polymer solution (A) was mixed with the carbon black dispersion (B) using a sonification machine for about 24 hours. To remove the solvent, the mixture was spread out on a tray, then the material was dried for 24 hours in ambient temperature. The dried composite material was applied to compression mold to make 0.5 mm thick film, then, cut as a 6 mm diameter disk. The obtained disk's electrical resistance was converted to the electrical conductivity and the value was 0.8×10⁻⁵ S/cm. Meanwhile to check the distribution state of carbon black particles in the polymer blend, the solution mixture before the drying process was spin-cast on a piece of cover glass, then, the obtained thin film's morphology was observed by an optical microscope, as shown in FIG. 3a.

### Comparative Example 3

25 g of SBR (Zeon Corporation, Nipol 1502) and 25 g of NBR (Zeon Corporation, Nipol 1042) were mixed by a Banbury mixer for 3 minutes, then, 2.5 g of carbon black (Cabot Corporation, Monarch 880) was added to the polymers and mixed for 10 minutes. The obtained composition material was applied to compression mold to make 0.5 mm thick film then, cut as a 6 mm diameter disk. The obtained disk's electrical resistance was converted to the electrical conductivity and the value was 0.9×10⁻⁹ S/cm.

According to the example, the electrical conductivity of the composite material obtained by the method of Example 3 is about 10,000 times higher than that of the composite material obtained by the conventional dry mixing method of comparative Example 3. This is because the carbon black was selectively localized at the interface between SBR and NBR phases and formed very effective network to increase the electrical conductivity. This interpretation is clearly supported by the micrograph shown in FIG. 3a. On the other hand, in the case of conventional dry mixing method described in the comparative Example 3, the carbon black was diluted by the whole polymers, then, electric conductive phase was not formed (FIG. 3b). Therefore, it was revealed that electrically high conductive composite material was successfully fabricated only a small amount of carbon black addition when the solution mixing process which caused uneven distribution of the carbon black at the interface between SBR and NBR phases was applied in this invention.

### Example 4

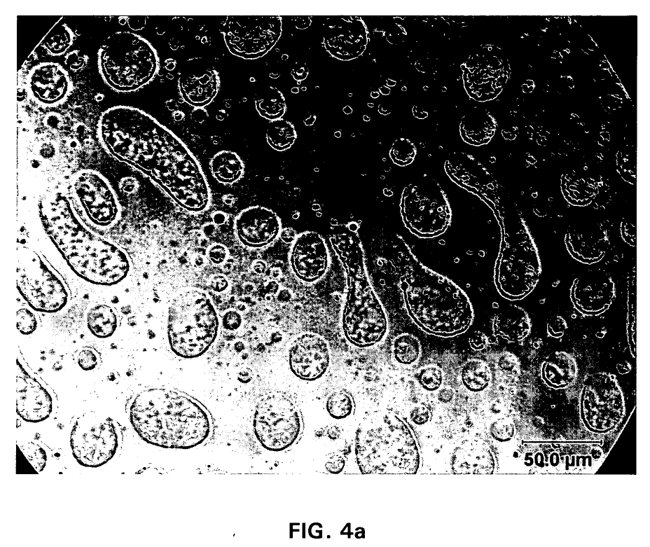

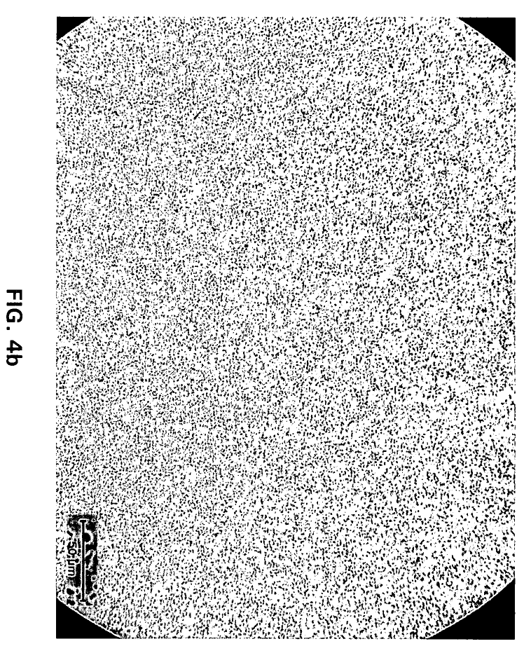

(A) 1.0 g of SBR (Zeon Corporation, Nipol 1502) and 1.0 g of NBR (Zeon Corporation, Nipol (1042) were completely dissolved into 20 ml of THF. (B) 0.1 g of fumed silica (Cabot Corporation, CAB-O-SIL M-5) was dispersed into 20 ml of toluene. Next, the polymer solution (A) and the fumed silica dispersion (B) were mixed. The mixture was applied using a sonification machine for about 24 hours. To check the distribution state of fumed silica particle in the polymer blend, the solution mixture was spin-cast on a piece of cover glass, then, the obtained thin film's morphology was observed by an optical microscope, as shown in FIG. 4a.

### Comparative Example 4

25 g of SBR (Zeon Corporation, Nipol 1502) and 25 g of NBR (Zeon Corporation, Nipol 1042) were mixed by a Banbury mixer for 3 minutes, then, 2.5 g of fumed silica (Cabot Corporation, CAB-O-SIL M-5) was added to the polymers and mixed for 10 minutes. The obtained composition material's morphology was observed by optical microscope, as shown in FIG. 4b.

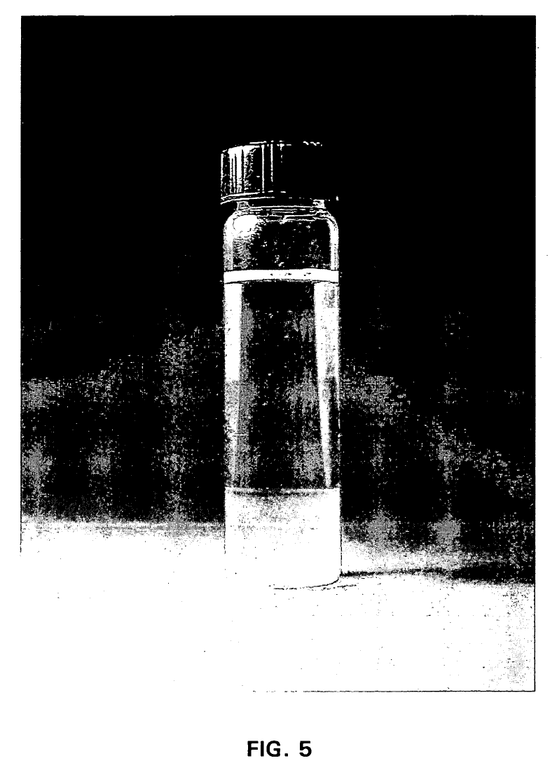

According to this example, as shown in FIG. 5, the fumed silica was unevenly distributed and concentrated only to the clouded bottom NBR phase and there was no silica in the upper clear SBR phase in the solution. This was checked by FT-IR spectroscopic analysis. The optical micrograph of the spin-cast film also shows uneven distribution of the fumed silica in NBR islands phase (FIG. 4a). On the other hand, in the case of the conventional dry mixing method described in the comparative Example 4, the fumed silica was diluted by the whole polymers (FIG. 4b). Therefore, it was revealed that controlled distribution of a filler in a polymer blend could also be accomplished utilizing non-electrically conductive fillers.

While this invention has been described with respect to improve the electrical conductivity of composite material, it is to be understood that the invention is not commited to the disclosed embodiments. To the contrary, the invention is intended to cover various modifications and equivalent arrangements included within the spirit and scope of the appended claims. For example, this invention can be applied for the improvement of material properties like shock absorbance, lubricity, optical property, permeability, biocompatibility, thermostability, shock resistance property, antiaging property, antiflex cracking resistance property, oil resistance property, waterproof property, ozone resistance property and the processability is also improved.

In accordance with the patent statutes, the best mode and preferred embodiment have been set forth, the scope of the invention is not limited thereto, but rather by the scope of the attached claims.

What is claimed is:

1. A method for preparing a composite material, comprising the steps of:
forming a solution comprising, at least a first polymer and a second polymer, a solvent component and a filler component;
mixing the solution; and
removing the solvent to form the composite material, said polymers having a solubility parameter difference between about 1.5 to about 3.5 MPa^{0.5}, and wherein the solvent component has a solubility parameter within about 1.5 to about 3.5 MPa^{0.5} of at least one polymer.

2. The method according to claim 1, wherein the first polymer is present in an amount from about 0.1 to 50 parts based on 100 parts by weight of the first polymer and second polymer, and wherein the filler is present in an amount from about 0.1 to about 1000 parts based on 100 parts by weight of the total polymer.

3. The method according to claim 1, wherein the solvent comprises n-pentane, n-hexane, n-heptane, diethyl ether, 1,1,1-tributylamine, n-dodecane, turpentine, cyclohexane, amyl acetate, carbon tetrachloride, xylene, ethyl acetate, toluene, tetrahydrofuran, benzene, chloroform, trichloroethylene, methyl ethyl ketone, acetone, diacetone alcohol, ethylene dichloride, methylene chloride, pyridine, morpholine, dimethylformamide, n-propyl alcohol, ethyl alcohol, dimethyl sulfoxide, n-butyl alcohol, methyl alcohol, propylene glycol, ethylene glycol, glycerol, water, or combinations thereof.

4. The method according to claim 1, wherein said first polymer and said second polymer are different and are derived from one or more monoolefins having from 2 to about 10 carbon atoms, derived from a monoolefin and non-olefin monomers, derived from conjugated diene having from 4 to about 8 carbon atoms or copolymers thereof, derived from vinyl aromatic monomers having from 8 to about 12 carbon atoms or copolymers thereof, a polyester, a polyvinyl alcohol, polyacetone, polyvinyl acetate, poly(alkyl) (alkyl)acrylate, a halogenated polymer, a polycarbonate, a polyamide, a polyether, a polysiloxane, poly(acrylonitrile, poly(cellulose), polyurethanes, a polyimide, polyacrylic acid, poly(amic acid), polyglycine, a polynucleotide, polyoxymethylene, a polypeptide, a poly(alkylene oxide); or incompletely cured and soluble epoxy, urethane, phenolic, unsaturated polyester, urea formaldehyde, vinyl ester, cyanate ester, bismaleimide, crosslinkable polyimide, or polybenzoxazine; or combinations thereof.

5. The method according to claim 4, wherein the filler is carbon black, a carbon black/silica dual phase material, graphite, fullerene, carbon nanotube, silica, mica, talc, clay, kaolin, wollastonite, calcium carbonate, calcium hydroxide, calcium metasilicate, zinc oxide, zirconium oxide, titanium oxide, tin oxide, tungsten oxide, lead oxide, nickel oxide, magnesium oxide, copper oxide, barium hydroxide, alumina, aluminum hydroxide, aluminum silicate, ferrite, molybdenum disulfide, feldspar powder, wood powder, metal powder, carbon fiber, aramid fiber, alumina fiber, potassium titanate whisker, glass fiber, glass sphere, synthetic fiber, ceramic spheres or particles, a pigment, or combination thereof.

6. The method according to claim 5, wherein the solubility parameter difference between the polymers is from about 1.8 to about 3.25 MPa^{0.5}.

7. The method according to claim 6, wherein the first polymer is present in an amount from about 1 to 30 parts per 100 parts by weight of total polymer, and wherein the filler is present in an amount from about 1 to about 100 parts based on 100 parts by weight of total polymer.

8. The method according to claim 7, wherein the first polymer is present in an amount from about 5 to 15 parts per 100 parts by weight of total polymer, and wherein the filler is present in an amount from about 3 to about 15 parts based on 100 parts by weight of total polymer, and wherein the mixing is performed with a mixer comprising sonic or ultrasonic waves, or a combination thereof.

9. The method according to claim 6, wherein the solubility parameter difference between the polymers is from about 2.0 to about 3.0 MPa^{0.5}.

10. The method according to claim 9, wherein the first polymer is styrene-butadiene rubber, and wherein the second polymer is nitrile rubber, wherein the solvent is toluene, chloroform, or tetrahydrofuran, and wherein the filler is conductive carbon black or silica.

11. A composite material having controlled filler distribution comprising:
a polymer component comprising at least a first polymer and a second polymer; and a filler component, wherein the polymers of the polymer component have a solubility parameter difference between about 1.5 to about 3.5 MPa^{0.5}, said filler distributed to greater extent about the first polymer or the second polymer, or substantially at an interface between the first polymer and the second polymer.

12. The material according to claim 11, wherein the first polymer is present in an amount from about 0.1 to 50 parts based on 100 parts by weight of the first polymer and second polymer, and wherein the filler is present in an amount from about 0.1 to about 1000 parts based on 100 parts by weight of the total polymer.

13. The material according to claim 11, wherein the solvent comprises: n-pentane, n-hexane, n-heptane, diethyl ether, 1,1,1-tributylamine, n-dodecane, turpentine, cyclohexane, amyl acetate, carbon tetrachloride, xylene, ethyl acetate, toluene, tetrahydrofuran, benzene, chloroform, trichloroethylene, methyl ethyl ketone, acetone, diacetone alcohol, ethylene dichloride, methylene chloride, pyridine, morpholine, dimethylformamide, n-propyl alcohol, ethyl alcohol, dimethyl sulfoxide, n-butyl alcohol, methyl alcohol, propylene glycol, ethylene glycol, glycerol, water, or combinations thereof.

14. The material according to claim 11, wherein said first polymer and said second polymer are different and are derived from one or more monoolefins having from 2 to about 10 carbon atoms, derived from a monoolefin and non-olefin monomers, derived from conjugated diene having from 4 to about 8 carbon atoms or copolymers thereof, derived from vinyl aromatic monomers having from 8 to about 12 carbon atoms or copolymers thereof, a polyester, a polyvinyl alcohol, polyacetone, polyvinyl acetate, poly(alkyl) (alkyl) acrylate, a halogenated polymer, a polycarbonate, a polyamide, a polyether, a polysiloxane, poly(acrylonitrile, poly(cellulose), polyurethanes, a polyimide, polyacrylic acid, poly(amic acid), polyglycine, a polynucleotide, polyoxymethylene, a polypeptide, a poly(alkylene oxide); or incompletely cured and soluble epoxy, urethane, phenolic, unsaturated polyester, urea formaldehyde, vinyl ester, cyanate ester, bismaleimide, crosslinkable polyimide, or polybenzoxazine; or combinations thereof.

15. The material according to claim 14, wherein the filler is carbon black, a carbon black/silica dual phase material, graphite, fullerene, carbon nanotube, silica, mica, talc, clay, kaolin, wollastonite, calcium carbonate, calcium hydroxide, calcium metasilicate, zinc oxide, zirconium oxide, titanium oxide, tin oxide, tungsten oxide, lead oxide, nickel oxide, magnesium oxide, copper oxide, barium hydroxide, alumina, aluminum hydroxide, aluminum silicate, ferrite, molybdenum disulfide, feldspar powder, wood powder, metal powder, carbon fiber, aramid fiber, alumina fiber, potassium titanate whisker, glass fiber, glass sphere, synthetic fiber, ceramic spheres or particles, a pigment, or combination thereof.

16. The material according to claim 15, wherein the solubility parameter difference between the polymers is from about 1.8 to about 3.25 MPa^{0.5}.

17. The material according to claim 16, wherein the first polymer is present in an amount from about 1 to 30 parts per 100 parts by weight of total polymer, and wherein the filler is present in an amount from about 1 to about 100 parts based on 100 parts by weight of total polymer.

18. The material according to claim 17, wherein the first polymer is present in an amount from about 5 to 15 parts per 100 parts by weight of total polymer, and wherein the filler is present in an amount from about 3 to about 15 parts based on 100 parts by weight of total polymer.

19. The material according to claim 16, wherein the solubility parameter difference between the polymers is from about 2.0 to about 3.0 MPa^{0.5}.

20. The material according to claim 19, wherein the first polymer is styrene-butadiene rubber, and wherein the second polymer is nitrile rubber, wherein the solvent is toluene, chloroform, or tetrahydrofuran, and wherein the filler is conductive carbon black or silica.

21. A composite material having controlled filler distribution, comprising:
a first polymer, a second polymer, and a filler component, said composite material produced by mixing the first polymer, second polymer and filler component in a solvent for a period of time and then removing the solvent, said polymers having a solubility parameter difference between about 1.5 to about 3.5 MPa^{0.5}, and wherein the solvent component has a solubility parameter within about 1.5 to about 3.5 MPa^{0.5} of at least one polymer.

22. The composite material according to claim 21, wherein said first polymer and said second polymer are different and are derived from one or more monoolefins having from 2 to about 10 carbon atoms, derived from a monoolefin and non-olefin monomers, derived from conjugated diene having from 4 to about 8 carbon atoms or copolymers thereof, derived from vinyl aromatic monomers having from 8 to about 12 carbon atoms or copolymers thereof, a polyester, a polyvinyl alcohol, polyacetone, polyvinyl acetate, poly(alkyl) (alkyl)acrylate, a halogenated polymer, a polycarbonate, a polyamide, a polyether, a polysiloxane, poly(acrylonitrile, poly(cellulose), polyurethanes, a polyimide, polyacrylic acid, poly(amic acid), polyglycine, a polynucleotide, polyoxymethylene, a polypeptide, a poly(alkylene oxide); or incompletely cured and soluble epoxy, urethane, phenolic, unsaturated polyester, urea formaldehyde, vinyl ester, cyanate ester, bismaleimide, crosslinkable polyimide, or polybenzoxazine; or combinations thereof.

23. The composite material according to claim 22, wherein the solvent comprises: n-pentane, n-hexane, n-heptane, diethyl ether, 1,1,1-tributylamine, n-dodecane, turpentine, cyclohexane, amyl acetate, carbon tetrachloride, xylene, ethyl acetate, toluene, tetrahydrofuran, benzene, chloroform, trichloroethylene, methyl ethyl ketone, acetone, diacetone alcohol, ethylene dichloride, methylene chloride, pyridine, morpholine, dimethylformamide, n-propyl alcohol, ethyl alcohol, dimethyl sulfoxide, n-butyl alcohol, methyl alcohol, propylene glycol, ethylene glycol, glycerol, water, or combinations thereof.

24. The composite material according to claim 22, wherein the first polymer is present in an amount from about 0.1 to 50 parts based on 100 parts by weight of the first polymer and second polymer, and wherein the filler is present in an amount from about 0.1 to about 1000 parts based on 100 parts by weight of the total polymer.

25. The composite material according to claim 24, wherein the first polymer is present in an amount from about 1 to 30 parts per 100 parts by weight of total polymer, and wherein the filler is present in an amount from about 1 to about 100 parts based on 100 parts by weight of total polymer.

26. The composite material according to claim 25, wherein the first polymer is present in an amount from about 5 to 15 parts per 100 parts by weight of total polymer, and wherein the filler is present in an amount from about 3 to about 15 parts based on 100 parts by weight of total polymer.

27. The composite material according to claim 26, wherein the solubility parameter difference between the polymers is from about 2.0 to about 3.0 MPa^{0.5}.

28. The composite material according to claim 27, wherein the first polymer is styrene-butadiene rubber, and wherein the second polymer is nitrile rubber, wherein the solvent is toluene, chloroform, or tetrahydrofuran, and wherein the filler is conductive carbon black or silica.

29. The composite material according to claim 21, wherein the mixing comprises using sonic or ultrasonic waves, or a combination thereof.
